(19) United States
(12) Patent Application Publication
(10) Pub. No.: US 2002/0013865 A1
(43) Pub. Date: Jan. 31, 2002

(54) System and method of a minimized representation of a sector variable-bits-per-inch table

(75) Inventors: CheeSeng Toh, Singapore (SG); KokSeng Lim, Singapore (SG); YongPeng Chng, Singapore (SG); Steven TianChye Cheok, Singapore (SG); SweeKieong Choo, Singapore (SG); KokHoe Chia, Singapore (SG)

Correspondence Address: SCHWEGMAN, LUNDBERG, WOESSNER & KLUTH, P.A., P.O. BOX 2938, MINNEAPOLIS, MN, 55402, US

(73) Assignee: Seagate Technology LLC

(21) Appl. No.: 09/887,649

(22) Filed: Jun. 22, 2001

Related U.S. Application Data
(60) Provisional application No. 60/220,721, filed on Jul. 26, 2000.

(51) Int. Cl. G06F 3/00

(52) U.S. Cl. 710/8; 710/16

(57) ABSTRACT

Systems and methods are provided through which a minimized sector variable-bits-per-inch table (MSVBPI) is generated during the design of the mass storage device. The MSVBPI table maps variable-bits-per-inch parameters to a head and zone. The retrieval of parameters is accomplished entirely from the MSVBPI table. Furthermore, the MSVBPI table is stored on the recording medium of the mass storage device. The firmware of the mass storage device is stored in the read-only-memory of the mass storage device. During the design of the mass storage device, after an initial compilation of the firmware, the firmware does not need to be recompiled when the content of the MSVBPI table is changed because the content of the MSVBPI and the firmware do not affect the content of each other.

### RELATED APPLICATION

This application claims the benefit of U.S. Provisional Application Ser. No. 60/220,721 filed Jul. 26, 2000 under 35 U.S.C. 119(e).

### FIELD OF THE INVENTION

This invention relates generally to disc drive configuration, and more particularly to representation of disc drive sector recording information.

### BACKGROUND OF THE INVENTION

Conventional disc drives use tables to store information on the organization and location of data on, and information on the servomechanism of the disc drive. Access time of the data depends on the ability to access the information in the tables. Conventionally, the architecture of these tables is complex, and accessing the tables is complex, and therefore slow.

Conventional disc drives implement variable-bits-per-inch (VBPI) recording tables. During the drive certification process, the maximum recording density scheme of the drive is determined and set at a point where the drive still has sufficient read channel margin under the worst-case combination of head, media and read channel distribution. To support this design, four VBPI tables are maintained in both the certification and customer firmware read-only memory (ROM).

FIG. 1 is a diagram of a conventional set 100 of table data structures for managing VBPI information, according to one embodiment. The four VBPI tables are a virtual physical disc table (VPDT) 110, a VBPI vector table (VVT) 120, a sector vector table (SVT) 130, and a sector VBPI (SVBPI) table 140. Each table is described in detail below:

Virtual Physical Disc Table (VPDT) 110

After drive certification, the VPDT 110 contains finalized VBPI configuration information 111 for each head 112 in the disc drive. There are a total of nineteen different configurations that can be set depending on the maximum recording density setting chosen for the disc drive.

VBPI Vector Table (VVT) 120

The VVT cross references configurations 121 with zones 122. Once a particular VBPI configuration is chosen, the VVT 120 lists the number of physical sectors per track allowed for the different recording zones on the media. For example, where the VPDT 110 indicates that the configuration 111 for head “0” 114 is configuration “02” 113, the VVT indicates that the number of physical sectors per track for configuration “02” 123 and zone “11” 124 is “370” 125.

Sector Vector Table (SVT) 130

The SVT 130 is a look-up table containing pointers to the address of a valid particular sector per track setting in the SVT 130. Any attempt to utilize an invalid sector per track setting returns a pointer to a null address. For example, the SVT 130 indicates that a valid particular sector per track setting 131 exists for a particular sector per track setting of “370.”

Sector VBPI (SVBPI) Table 140

To achieve a certain recording density setting (or physical sectors per track), a set 141 of predetermined read/write channel and drive controller parameters are needed to configure the disc drive electronics for proper operation. The SVBPI table 140 contains these parameters 141 for the different sector per track settings. In one example, the parameters include split length (“sp len”) 143, sector frequency (“sfreq”) 144, gap length plus base counter (“gapsz bscnt”) 145, M register & N register (“m&n”) 146, wedge size (“BPS”) 147, modified not return to zero (NRZ) frequency (“modnrz”) 148, and “recording freq” 149.

For example, for a sector per track setting of 370 (block 142), the recording frequency 149 is 175.328.

The conventional four-table design has several disadvantages. One disadvantage to the conventional design is that, unlike drive certification firmware that requires all nineteen VBPI configurations to be available during testing, the disc drive firmware only needs the optimum VBPI configurations to function. The optimum VBPI configurations are fewer in number than all nineteen VBPI configurations available during testing. The non-optimal VBPI configurations do not need to be stored in the read-only-memory (ROM) of the disc drive, yet the non-optimal VBPI configurations are stored in the ROM. Therefore, the conventional design requires superfluous storage of non-optimal configurations in the ROM of the disc drive.

A further disadvantage is the storage of redundant information. In order to provide linking indices between the tables, the linking index information is stored in any two tables that are linked. For example the VBPI configuration 111 and 121 is stored in the both the VPDT table 110, and the VVT table 120. The number of sectors per track is stored in both the VVT table 120 and the SVT table 130 and the SVBPI table 140.

Another disadvantage is that the four tables, the VPDT, the VVT, the SVT, and the SVBPI table, are traversed each time the required parameters are fetched. This slows down the fetch process, and ultimately slows down disc drive performance.

Still another disadvantage is that during disc drive development, the disc drive firmware needs to be re-compiled each time VBPI parameters are changed. The firmware needs to be re-compiled each time the parameters are changed because the SVBPI table is stored in ROM on the disc drive.

FIG. 2 is a flowchart of a conventional method 200 of maintaining a sector variable-bits-per-inch table during the design stage of a disc drive. The conventional method 200 starts with compiling the firmware code 210, using the VBPI parameters. Thereafter, when a change in the VBPI parameters is identified 220, a new SVBPI table is generated 230, and the method is performed again, including compiling the firmware code 210. Each time a change in the VBPI parameters is identified 220, the firmware code is compiled 230.

What is needed is a representation of the VBPI parameter that does not require compiling the firmware code during the design of the disc drive each time the VBPI parameters change. What is also needed is easier retrieval during operation of the disc drive of VBPI parameters for each head and zone. More space efficient representation of the VBPI table on the disc drive is also needed.

### SUMMARY OF THE INVENTION

The above-mentioned shortcomings, disadvantages and problems are addressed by the present invention, which will be understood by reading and studying the following specification.

The present invention provides system, methods and apparatus to implement existing VBPI tables as a singular minimized sector variable-bits-per-inch (MSVBPI) table on the storage medium of a mass storage device. Storing the MSVBPI table on the storage medium separates the VBPI parameter information from the read-only-memory of the mass storage device. As result, the generation of the table is a process that does not need to be repeated each time the VBPI information changes. Storing the MSVBPI table on the storage medium also provides more available space on ROM for additional firmware code. In addition, the VBPI parameter information is stored in one table on the storage medium, which reduces the complexity of the process of obtaining the VBPI information, which improves the speed of the obtaining and reduces the expense of designing, writing and maintaining the firmware and/or software that obtains the VBPI information.

In one aspect of the present invention, a computerized method for configuring an electronic device includes compiling firmware code once and generating a representation of a MSVBPI from a first set of VBPI parameters.

In another aspect of the present invention, an apparatus includes a compiler of firmware code, and a generator operably coupled to the compiler, of a representation of a MSVBPI table from a first set of VBPI parameters.

In yet another aspect of the present invention, a computerized method for obtaining one or more VBPI parameters of an electronic device includes receiving a request for the one or more VBPI parameters of the electronic device, in which the request includes an indication of a head and an indication of a zone, and obtaining the one or more VBPI parameters of the electronic device from a MSVBPI table, from the indication of the head and an indication of the zone. In still another aspect of the present invention, an apparatus for obtaining one or more VBPI parameters of an electronic device includes a receiver of a request for the one or more VBPI parameters of the electronic device, the request including an indication of a head and an indication of a zone and an obtainer of the one or more VBPI parameters from the MSVBPI table, from the indication of the head and an indication of the zone.

The present invention has the advantage of reducing the storage space requirements of VBPI tables. In addition, the present invention also enables the VPBI information to be stored on the system sector on the storage medium, rather than on the read-only-memory (ROM) of the disc drive, freeing the ROM for other uses.

The present invention also has the advantage of eliminating the need to compile the disc drive firmware each time the MSVBPI parameters are modified. Because the MSVBPI is stored in the re-writeable system sector on the media, when the MSVBPI changes, a new MSVBPI table is generated and downloaded to the system sector, replacing the old MSVBPI table. Thus, the firmware does not need to be regenerated.

The present invention also has the advantage of overall simplification of the VBPI parameter fetch process. The required parameters are fetched in a single step without the need to traverse through four different tables.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a diagram of a conventional set of table data structures for managing VBPI information.

FIG. 2 is a flowchart of a conventional method of maintaining a sector variable-bits-per-inch table during the design stage of a disc drive.

FIG. 3 is a block diagram that provides a system level overview of the operation of embodiments of the present invention.

FIG. 4 is a flowchart of a computerized method for configuring a disc drive, according to an embodiment of the present invention.

FIG. 5 is a diagram of table data structures for managing MSVBPI information, according to an embodiment directed to a disc drive.

FIG. 6 is a flowchart of a computerized method for configuring an electronic device, according to an embodiment of the present invention.

FIG. 7 is a flowchart of a computerized method for managing a MSVBPI table of an electronic device, according to an embodiment of the present invention.

FIG. 8 is a flowchart of a computerized method 800 for obtaining one or more VBPI parameters of an electronic device, according to an embodiment of the present invention.

FIG. 9 is a block diagram of a computerized apparatus for configuring an electronic device, according to an embodiment of the present invention.

FIG. 10 is a block diagram of a computerized apparatus for obtaining one or more VBPI parameters of an electronic device, according to an embodiment of the present invention.

FIG. 11 is an exploded view of one embodiment of a disc drive of the present invention

FIG. 12 is a schematic view of a computer system.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is to be understood that other embodiments may be utilized and structural changes may be made without departing from the scope of the present invention.

The detailed description is divided into four sections. In the first section, a system level overview of the invention is presented. In the second section, the apparatus of the invention is described. In the third section, methods for an embodiment of the invention are provided. Finally, in the fourth section, a conclusion of the detailed description is provided.

### System Level Overview

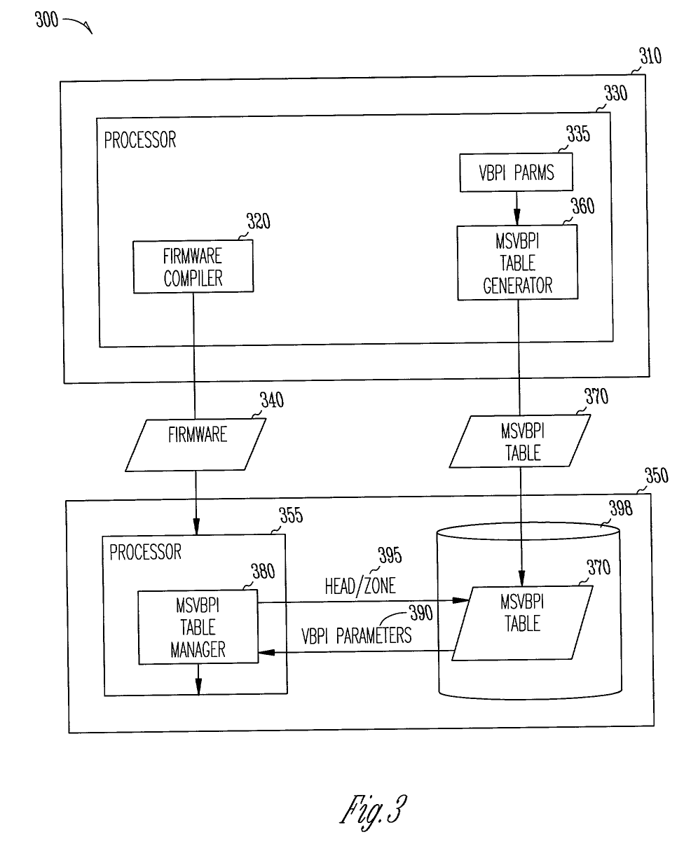

FIG. 3 is a block diagram that provides a system level overview 300 of the operation of embodiments of the present invention. Embodiments of the invention operate in a multi-processing, multi-threaded operating environment on a computer, such as computer 1200 in FIG. 12.

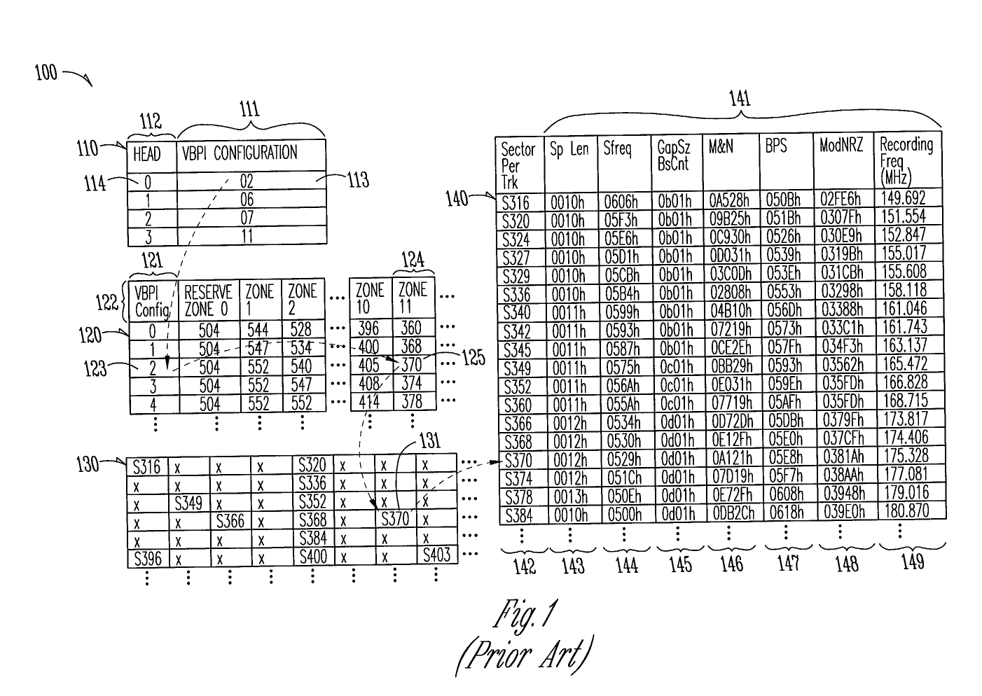

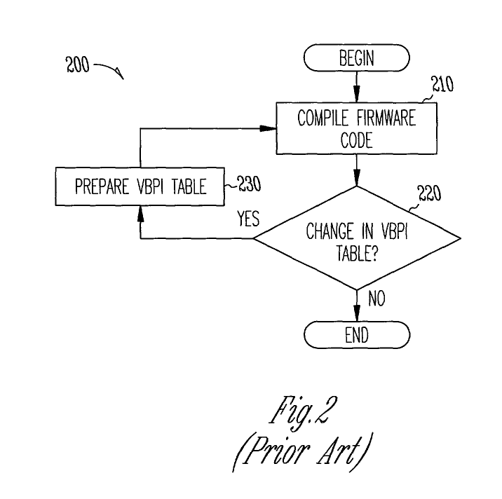

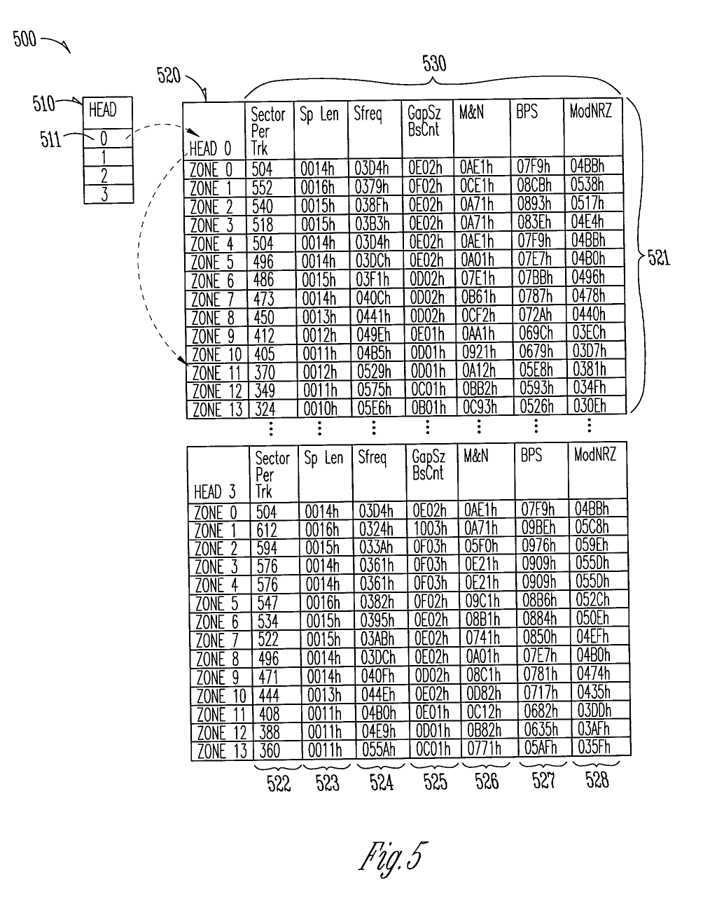

System 300 generates and uses a minimized sector variable-bits-per-inch (MSVBPI) table 370. An electronic device 310 includes a generator 360 of the MSVBPI table 370. The MSVBPI table generator 360 is also operative on the processor 330. The MSVBPI table generator 360 is a means for generating a minimized representation of a sector variable-bits-per-inch (VBPI) table 370 of a disc drive 350. The representation includes an index to a disc drive head, an index to a disc drive zone, and an associated sector-per-track data in a singular table. The MSVBPI table 370 is generated from VBPI parameters 335. The MSVBPI table 370 has the advantage of reducing the storage space requirements of the multiple VBPI tables of conventional solutions that is described in conjunction with FIGS. 1 and 2, above. The MSVBPI table 370 aggregates VBPI information 335 into one table, as is discussed in detail in conjunction with FIG. 5 below. The minimized table 370 reduces redundancy in the storage of VBPI information.

The disc drive 350 includes a means for managing 380 the MSVBPI table 370 that is downloaded to the disc drive 350, and stored on the storage medium 398 of the disc drive 350. Storing the MSVBPI table 370 on the storage medium 398 of the disc drive 350, rather than on the read-only-memory (ROM) of the disc drive of conventional systems, has the advantage of making storage capacity of the ROM available for other uses.

The MSVBPI table manager 380 obtains the VBPI parameters 390 that are indexed by the head and zone 395. Obtaining the VBPI parameters through one table 370 has the advantage of overall simplification of the VBPI parameter fetch process. The required parameters are fetched in a single step without the need to traverse through four different tables.

In one example, an electronic device 310, such as computer 1200 in FIG. 12, includes a firmware compiler 320 operative on a processor 330. The firmware compiler 320 generates firmware 340 that is downloaded to the storage medium 380 of a disc drive 350. Compilation of the firmware 340 is independent of the generation of the MSVBPI table because the MSVBPI table 370 is stored on the storage medium 389 of the disc drive 350. Thus, the firmware does not need to be regenerated when the VBPI parameter 335 change.

System 300 provides a representation 370 of the VBPI parameters 335 that does not require compiling the firmware code 340 during the design of the disc drive 350 each time the VBPI parameters change, that provides easier retrieval during operation of the disc drive 350 of VBPI parameters for each head and zone 350 and 390, and that provides more space efficient representation 370 of the VBPI table on the disc drive 350.

### Methods of an Embodiment of the Invention

In the previous section, a system level overview of the operation of an embodiment of the invention was described. In this section, the particular methods performed by the server and the clients of such an embodiment are described by reference to a series of flowcharts. Describing the methods by reference to a flowchart enables one skilled in the art to develop such programs, firmware, or hardware, including such instructions to carry out the methods on suitable computerized clients (the processor of the clients executing the instructions firm computer-readable media). Similarly, the methods performed by the server computer programs, firmware, or hardware are also composed of computer-executable instructions. Describing the methods by reference to flowcharts enables one skilled in the art to develop programs, firmware, or hardware, including instructions to carry out the methods on a suitable computerized server (the processor of the clients executing the instructions from computer-readable media). Methods 400, 600-800 are performed by a program executing on, or performed by firmware or hardware that is a part of, a computer, such as computer 1200 in FIG. 12

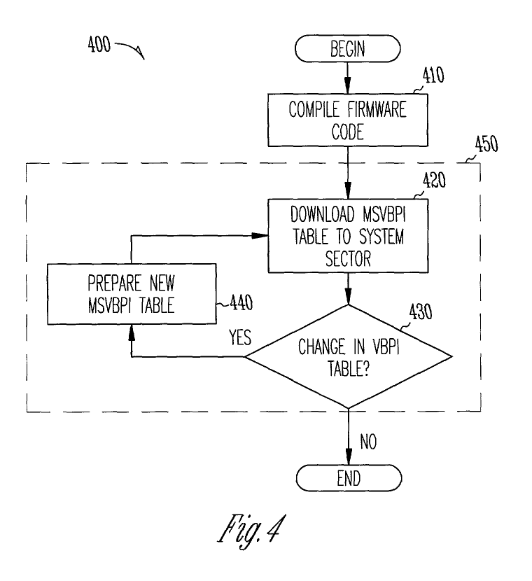

FIG. 4 is a flowchart of a computerized method 400 for configuring a disc drive 350, according to an embodiment of the present invention. Method 400 includes compiling 410 firmware code, such as firmware code 340 in FIG. 3. Thereafter, the method begins loop 450 that ends when the configuration process of the disc drive is complete. The loop 450 in method 400 begins by downloading 420 a minimized sector variable-bits-per-inch (MSVBPI) table to the system sector of the disc drive. Thereafter, when a change in a variable-bits-per-inch (VBPI) table is detected 430, a new MSVBPI table is prepared 440. The information in the MSVBPI table 370 is prepared independent of information in the firmware code 340.

The loop 450 is exited when no changes in a VBPI table are detected 430, which occurs, in one embodiment, after the configuration process of a disc drive is complete.

The outcome of the compiling step 410 and the preparing step 440 are not dependent upon the outcome of each other because the firmware 340 and the MSVBPI table 370 are designated for separate media storage embodiments. Storing the MSVBPI table 370 on the disc drive 350, rather than on the read-only-memory (ROM) of the disc drive of conventional systems, has the advantage of making storage capacity of the ROM available for other uses.

FIG. 5 is a diagram of table data structures 500 for managing of MSVBPI information, according to an embodiment directed to a disc drive. The table data structures include a lookup table 510 and a MSVBPI table 520. The MSVBPI table 520 is also disclosed as MSVBPI table 370 in FIG. 3.

The lookup table 510 indicates the portion of the MSVBPI table 520 that is associated with each head of the disc drive. For example, for head “0” 511, the portion of the MSVBPI table 520 associated with head “0” is portion 521. The MSVPBI table 520 enables the head and zone of the disc drive to be cross-referenced to indicate the VBPI associated VBPI information. The required head and zone numbers are used to offset into the MSVBPI table 520 to obtain the necessary VBPI parameters 530. As shown in FIG. 5, the MSVBPI table 520 contains only the VBPI parameters 530 of the optimum VBPI configuration. In one embodiment, the VBPI parameters 530 are substantially similar to the VBPI parameters 335 in FIG. 3. VBPI parameters 530 include, sectors per track 522, split length (“sp len”) 523, sector frequency (“sfreq”) 524, gap length plus base counter(“gapsz bscnt”) 525, M register & N register (“m&n”) 526, wedge size (“BPS”) 527, and modified not return to zero (NRZ) frequency (“modnrz”) 528. In conventional systems, the sectors per track 522 is stored in the VBPI Vector Table (VVT) 120 in FIG. 1, and the “sp len” 523, “sfreq” 524, “gapsz bscnt” 525, “m&n” 526, “BPS” 527, and “modnrz” 528 are stored in the VBPI (SVBPI) table 140 in FIG. 1. The MSVBPI table 520 has the advantage of reducing the storage space requirements of the multiple VBPI tables of conventional solutions that is described in conjunction with FIGS. 1 and 2, above. The minimized table 520 reduces redundancy in the storage of VBPI information. The MSVBPI table 520 stores only the optimum VBPI configurations, thus making more efficient use of available storage space.

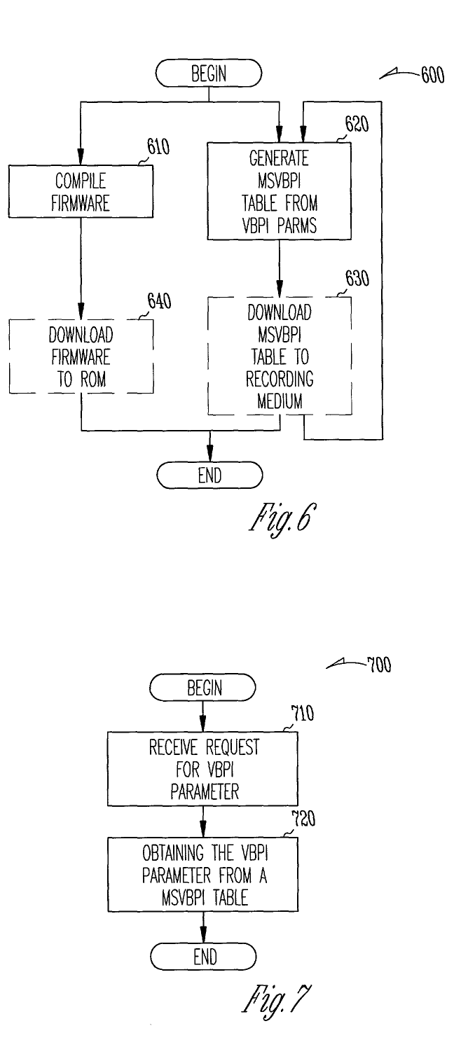

FIG. 6 is a flowchart of a computerized method 600 for configuring an electronic device 350, according to an embodiment of the present invention. Method 600 includes compiling 610 firmware code 340 for the electronic device 350 and generating 620 a representation of a MSVBPI table from a first set of VBPI parameters. In one embodiment, the MSVBPI table is substantially similar to the MSVBPI table 370 in FIG. 3 and the MSVBPI table 520 in FIG. 5. In another embodiment, the VBPI parameters are substantially similar to the VBPI parameters 335 in FIG. 3 and the VBPI parameters 530 in FIG. 5. In varying embodiments, the generating step 620 is performed before, during or after, the compiling step 610, because the compiling step 610 and the generating step 620 are independent processes. The outcome of the compiling step 610 and the generating step 620 are not dependent upon the outcome of each other because the firmware 340 and the MSVBPI table are designated for separate media storage embodiments.

In one example of method 600 where the electronic device is a disc drive, the MSVBPI table is generated after disc drive certification when the optimum VBPI configuration of the heads has been determined.

Method 600 also includes downloading 640 the firmware code 340 to a ROM of the mass storage device.

In one example where the electronic device 350 is a mass storage device, method 600 also includes downloading 630 the representation of a MSVBPI table to a recording medium 398 of the mass storage device. In one embodiment, the mass storage device is a disc drive 350, the MSVBPI table is downloaded 630 to a reserved area, such as the system sector, on the mass storage media 398. Each time the mass storage device is powered-up, the MSVBPI table 370 is loaded from the media into RAM memory for normal operation of the mass storage device. Downloading 630 the MSVBPI table 370 on the storage medium 398 of the disc drive 350, rather than on the read-only-memory (ROM) of the disc drive of conventional systems, has the advantage of making storage capacity of the ROM available for other uses.

In another example, method 600 also includes receiving a second set of VBPI parameters and generating 620 the representation of a MSVBPI table 370 from the second set of VBPI parameters. In yet another example, method 600 also includes generating the representation of a MSVBPI table 370 from the set of VBPI parameters that was most recently received, such as the 2^{nd} set of VBPI parameters.

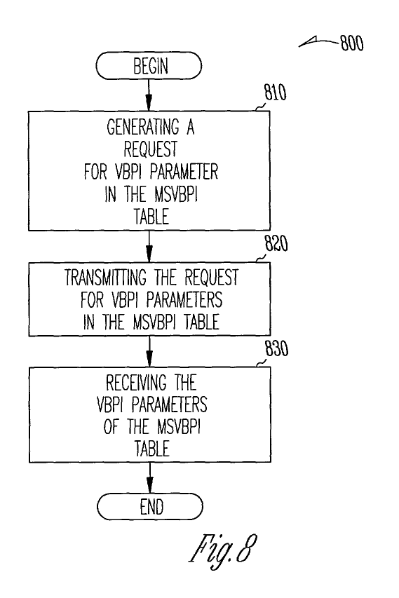

FIG. 7 is a flowchart of a computerized method 700 for managing a MSVBPI table of an electronic device, according to an embodiment of the present invention. Method 700 includes receiving 710 a request for one or more VBPI parameters of the electronic device. The request includes an indication of a head and an indication of a zone. In varying embodiments, the electronic device is a mass storage device, such as a disc drive table. In another embodiment, the MSVBPI table is stored on a system sector of the recording medium of the mass storage device. In one embodiment, the MSVBPI table is substantially similar to the MSVBPI table 370 in FIG. 3 and the MSVBPI table 520 in FIG. 5. In another embodiment, the VBPI parameters are substantially similar to the VBPI parameters 335 in FIG. 3 and the VBPI parameters 530 in FIG. 5.

Subsequently, method 700 includes obtaining 720 the requested one or more VBPI parameters of the electronic device 350 from a MSVBPI table, from the indication of the head and an indication of the zone.

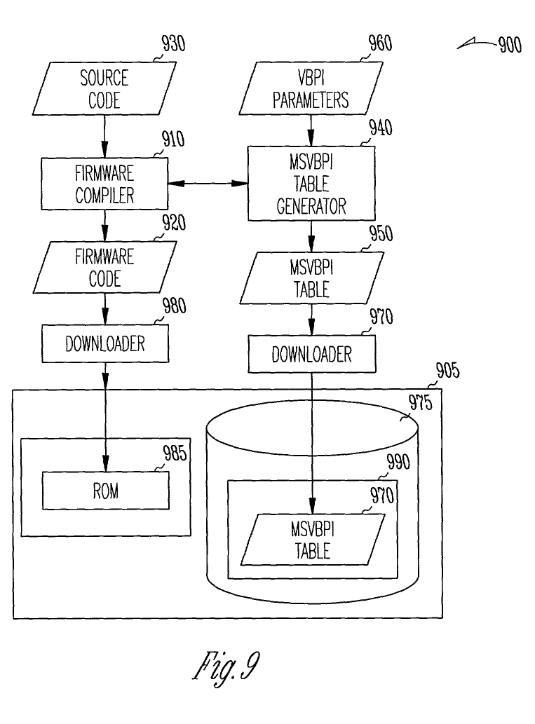

FIG. 8 is a flowchart of a computerized method 800 for obtaining 710 one or more VBPI parameters of an electronic device 350, according to an embodiment of the present invention. Method 800 includes generating 810 a request for the one or more VBPI parameters of the electronic device 350, from the indication of a head and an indication of a zone that was received in step 710. Thereafter, the method 820 includes transmitting 820 the request to a manager of the MSVBPI table. Subsequently, method 800 includes receiving 830 the one or more VBPI parameters 335. In one embodiment, the MSVBPI table is substantially similar to the MSVBPI table 370 in FIG. 3 and the MSVBPI table 520 in FIG. 5. In another embodiment, the VBPI parameters are substantially similar to the VBPI parameters 335 in FIG. 3 and the VBPI parameters 530 in FIG. 5.

### Apparatus

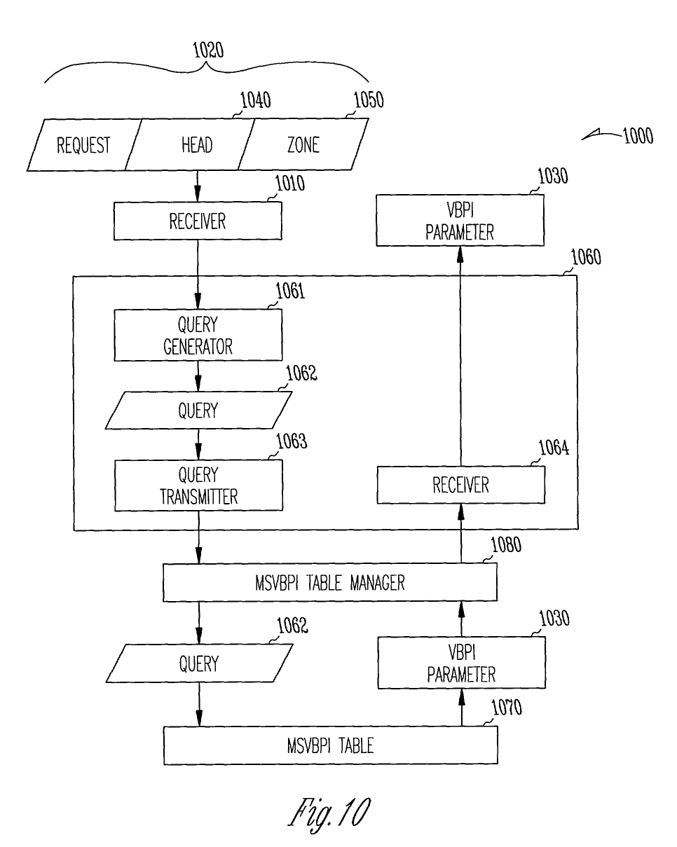

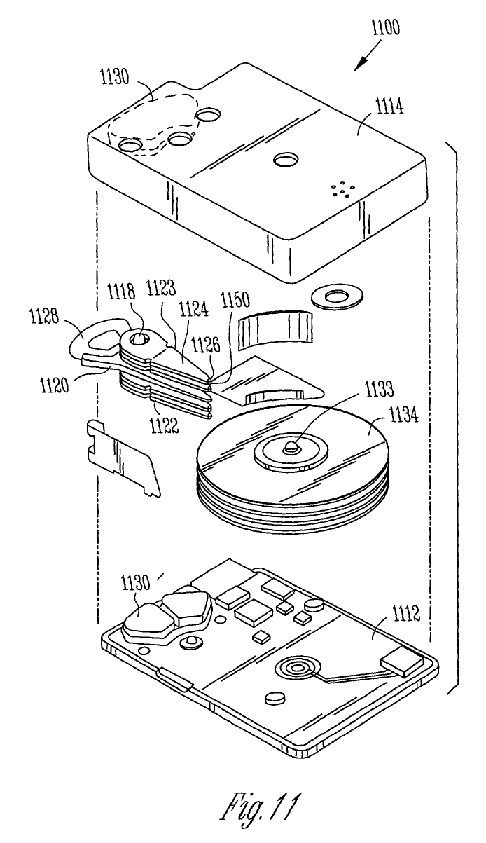

Referring to FIGS. 9-10, apparatus of the invention is described in conjunction with the system overview in FIG. 3. FIG. 9 is a block diagram of a computerized apparatus 900 for configuring an electronic device 905, according to an embodiment of the present invention.

Apparatus 900 includes a compiler 910 of firmware code 920 from firmware source code 930. In one embodiment, the compiler 910 is substantially similar to the firmware compiler 320 in FIG. 3. In one embodiment, the firmware code 920 is substantially similar to firmware 340 in FIG. 3. In another embodiment, the compiler 910 performs the step of compiling 410 in FIG. 4.

Apparatus 900 also includes a generator 940 of a representation of a MSVBPI table 950 from a first set of VBPI parameters 960. In one embodiment, the generator 940 is substantially similar to the generator 360 in FIG. 3. In another embodiment, the MSVBPI table 950 is substantially similar to the MSVBPI table 370 in FIG. 3. In yet another embodiment, the VBPI parameters 960 are substantially similar to the VBPI parameters 335 in FIG. 3. The generator 940 is operably coupled to the compiler 910. All of the VBPI parameters 960 are stored in the MSVBPI table 950 in order to reduce the total storage space of the VBPI parameters 960 on the electronic device, and in order to facilitate less complicated and faster retrieval of the VBPI parameters 960.

Where the electronic device 905 is a mass storage device, the apparatus 900 also includes a downloader 970 of the representation of a MSVBPI table 950 to a recording medium 975 of the mass storage device. The downloader 970 performs the step of downloading 420 in FIG. 4. The downloader 970 is operably coupled to the generator 940. Furthermore, where the electronic device is a mass storage device, the apparatus 900 also includes a downloader 980 of the firmware code 920 to a read-only-memory 985 of the mass storage device. The downloader 980 is operably coupled to the compiler 910.

Where the mass storage device is a disc drive, the downloader 970 is a downloader 970 of the representation of a MSVBPI table 950 to a system sector 990 of the recording medium 975 of the disc drive. Storing the MSVBPI table 950 on the system sector 990 of the recording medium 975 of the disc drive 350, rather than on the read-only-memory of the disc drive of conventional systems, has the advantage of making storage capacity of the ROM available for other uses.

FIG. 10 is a block diagram of a computerized apparatus 1000 for obtaining one or more VBPI parameters 1030 of an electronic device, according to an embodiment of the present invention. Apparatus 1000 includes a receiver 1010 of a request 1020 for one or more VBPI parameters 1030 of the electronic device. The receiver 1010 performs the step of receiving 710 in FIG. 7. The request 1020 includes an indication of a head 1040 and an indication of a zone 1050. In one embodiment, the one or more VBPI parameters 1030 are substantially similar to the VBPI parameters 335 in FIG. 3. In varying embodiments, the request is an instruction or a command.

The apparatus 1000 also includes an obtainer 1060 of the one or more VBPI parameters 1030 of the electronic device from a MSVBPI table 1070, from the indication of the head 1040 and an indication of the zone 1050. In one embodiment, the MSVBPI table 1070 is substantially similar to the MSVBPI table 370 in FIG. 3.

In one example, the obtainer 1060 includes a generator 1061 of a query 1062 for the one or more VBPI parameters 1030 of the electronic device, from the indication of a head 1040 and an indication of a zone 1050. The obtainer 1060 also includes a transmitter 1063 of the query 1062 to a manager 1080 of the MSVBPI table 1070 and a receiver 1064 of the one or more VBPI parameters 1030 from the manager 1080. In one embodiment, the manager 1080 of the MSVBPI table 1070 is substantially to MSVBPI table manager 380 in FIG. 3. The retrieval of VBPI parameters 1030 from MSVBPI table 1070 by manager 1080 is performed more faster and with fewer steps because the VBPI information is contained in the singular MSVBPI table 1070, in comparison to the distributed nature of the multiple tables in conventional systems described in conjunction with FIG. 1.

In another example of apparatus 1000 where the electronic device further comprises a mass storage device and the MSVBPI table 1070 is stored on a system sector of the recording medium of the mass storage device. In a further example, the mass storage device further comprises a disc drive and the manager 1080 references only the MSVBPI table 1070 to retrieve a number of sectors per track VBPI parameter.

The components of apparatus 900 and 1000 can be embodied as computer hardware circuitry or as a computer-readable program, or a combination of both.

More specifically, in the computer-readable program embodiment, the programs can be structured in an object-orientation using an object-oriented language such as Java, Smalltalk or C++, and the programs can be structured in a procedural-orientation using a procedural language such as C or assembly language. The software components communicate in any of a number of means that are well-known to those skilled in the art, such as application program interfaces (A.P.I.) or interprocess communication techniques such as remote procedure call (R.P.C.), common object request broker architecture (CORBA), Component Object Model (COM), Distributed Component Object Model (DCOM), Distributed System Object Model (DSOM) and Remote Method Invocation (RMI).

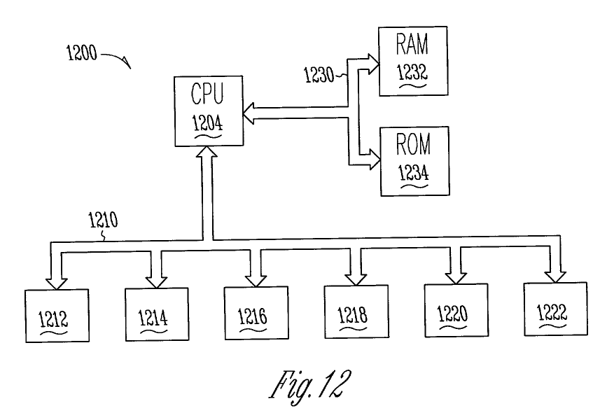

FIG. 11 is an exploded view of one embodiment of a disc drive of the present invention, this embodiment showing one type of magnetic disc drive 1100 having a rotary actuator. The disc drive 1100 is one example of mass storage devices, such as compact disc (CDROM) devices, tape cartridge devices, digital versatile disc (DVD) or digital video disc (DVD) devices. Other embodiments include other configurations and data recording and/or reading technologies. The disc drive 1100 includes a housing or base 1112, and a cover 1114. The base 1112 and cover 1114 form a disc enclosure. Rotatably attached to the base 1112 on an actuator shaft 1118 is an actuator assembly 1120. The actuator assembly 1120 includes a comb-like structure 1122 having a plurality of arms 1123. Attached to the separate arms 1123 on the comb 1122, are load beams or load springs 1124. Load beams or load springs are also referred to as suspensions. Attached at the end of each load spring 1124 is a slider 1126, which carries a magnetic transducer 1150. In some embodiments, transducer 1150 includes an electromagnetic coil write head 97 and a magneto-resistive read head 98. The slider 1126 with the transducer 1150 form what is often called the head. It should be noted that many sliders have one transducer 1150 and that is what is shown in the figures. It should also be noted that this invention is equally applicable to sliders having more than one transducer, such as what is referred to as an MR or magneto resistive head in which one transducer 1150 is generally used for reading and another is generally used for writing. On the end of the actuator assembly 1120 opposite the load springs 1124 and the sliders 1126 is a voice coil 1128.

Attached within the base 1112 is a first magnet 1130 and a second magnet 1131. As shown in FIG. 11, the second magnet 1131 is associated with the cover 1114. The first and second magnets 1130, 1131, and the voice coil 1128 are the key components of a voice coil motor which applies a force to the actuator assembly 1120 to rotate it about the actuator shaft 1118. Also mounted to the base 1112 is a spindle motor. The spindle motor includes a rotating portion called a spindle hub 1133. In this particular disc drive, the spindle motor is within hub 1133. In FIG. 11, a number of discs 1134 (one or more; four are shown) are attached to the spindle hub 1133 to form disc assembly 1132. In other disc drives, a single disc or a different number of discs may be attached to the hub. The invention described herein is equally applicable to disc drives which have a plurality of discs as well as disc drives that have a single disc. The invention described herein is also equally applicable to disc drives with spindle motors that are within the hub 1133 or under the hub.

FIG. 12 is a schematic view of a computer system. Advantageously, the invention is well suited for use in a computer system 1200. The computer system 1200 may also be called an electronic system or an information handling system and includes a central processing unit, a memory and a system bus. The information handling system includes a central processing unit 1204, a random access memory 1232, and a system bus 1230 for communicatively coupling the central processing unit 1204 and the random access memory 1232. The information handling system may also include an input/output bus 1210 and several peripheral devices, such as 1212, 1214, 1216, 1218, 1220, and 1222 that may be attached to the input output bus 1210. Peripheral devices may include hard disc drives, magneto-optical drives, floppy disc drives, monitors, keyboards and other such peripherals. Any type of disc drive may include a bearing cartridge characterized according to the teaching of the present invention.

### Conclusion

In conclusion, systems and methods are disclosed through which a system for configuring an electronic device 310 includes a processor 355 and a means 380 operative on the processor 355 for managing a minimized representation of a sector variable-bits-per-inch table 370 of a disc drive 350, the representation including an index to a disc drive head, an index to a disc drive zone, and an associated sector-per-track data.

A method 600 for configuring an electronic device 350 includes compiling 610 firmware code for the electronic device and generating 620 a representation of a minimized sector variable-bits-per-inch (MSVBPI) table from a first set of variable-bits-per-inch (VBPI) parameters 335. In varying embodiments, the generating step 620 is performed before, during or after, the compiling step 610, because the compiling step 610 and the generating step 620 are independent processes. The outcome of the compiling step 610 and the generating step 620 are not dependent upon the outcome of each other because the firmware 340 and the MSVBPI table 370 are designated for separate media storage embodiments. In one embodiment, the firmware code is substantially similar to the firmware code 340 in FIG. 3 and the electronic device is substantially similar to the electronic device 350 in FIG. 3.

In one example where the electronic device 350 is a mass storage device, method 600 also includes downloading 630 the representation of a MSVBPI table 370 to a recording medium 398 of the mass storage device. In one embodiment, the mass storage device is a disc drive 350, the MSVBPI table 370 is downloaded 630 to a system sector of the recording medium 398 of the disc drive. The method 600 also includes downloading 640 the firmware code 340 to a read-only-memory of the mass storage device.

In another example, method 600 also includes receiving a second set of VBPI parameters and generating 620 the representation of a MSVBPI table 370 from the second set of VBPI parameters. In yet another example, method 600 also includes generating the representation of a MSVBPI table 370 from the set of VBPI parameters that was most recently received, such as the 3^{rd} set of VBPI parameters.

Method 700 for managing a MSVBPI table 370 of an electronic device 350 includes receiving 710 a request for one or more variable-bits-per-inch parameters 335 of the electronic device 350. The request includes an indication of a head and an indication of a zone. In varying embodiments, the electronic device is a mass storage device, such as a disc drive table. In another embodiment, the MSVBPI table 370 is stored on a system sector of the recording medium of the mass storage device. Subsequently, method 700 includes obtaining 720 the requested one or more VBPI parameters 335 of the electronic device 350 from a MSVBPI table 370, from the indication of the head and an indication of the zone.

Method 800 for obtaining 710 one or more VBPI parameters 335 of the electronic device 350 includes generating 810 a request for the one or more VBPI parameters of the electronic device 350, from the indication of a head and an indication of a zone that was received in step 710. Thereafter, the method 820 includes transmitting 820 the request to a manager of the MSVBPI table 370. Subsequently, method 800 includes receiving 830 the one or more VBPI parameters 335.

Apparatus 900 for configuring an electronic device 905 includes a compiler 910 of firmware code 920 from firmware source code 930. Apparatus 900 also includes a generator 940 of a representation of a MSVBPI table 950 from a first set of VBPI parameters 960. The generator 940 is operably coupled to the compiler 910.

Where the electronic device 905 is a mass storage device, the apparatus 900 also includes a downloader 970 of the representation of a MSVBPI table 950 to a recording medium 975 of the mass storage device. The downloader 970 is operably coupled to the generator 940. Furthermore, where the electronic device is a mass storage device, the apparatus 900 also includes a downloader 980 of the firmware code 920 to a read-only-memory 985 of the mass storage device. The downloader 980 is operably coupled to the compiler 910.

Where the mass storage device is a disc drive, the downloader 970 of the representation includes a downloader 970 of the representation of a MSVBPI table 950 to a system sector 990 of the recording medium 975 of the disc drive.

Apparatus 1000 for obtaining one or more VBPI parameters 1030 of an electronic device includes a receiver 1010 of a request 1020 for one or more VBPI parameters 1030 of the electronic device. The request 1020 includes an indication of a head 1040 and an indication of a zone 1050. The apparatus 1000 also includes an obtainer 1060 of the one or more VBPI parameters 1030 of the electronic device from a MSVBPI table 1070, from the indication of the head 1040 and an indication of the zone 1050.

In one example, the obtainer 1060 includes a generator 1061 of a query 1062 for the one or more VBPI parameters 1030 of the electronic device, from the indication of a head 1040 and an indication of a zone 1050. The obtainer 1060 also includes a transmitter 1063 of the query 1062 to a manager 1080 of the MSVBPI table 1070 and a receiver 1064 of the one or more VBPI parameters 1030 from the manager 1080.

In another example of apparatus 1000 where the electronic device further comprises a mass storage device and the MSVBPI table 1070 is stored on a system sector of the recording medium of the mass storage device. In a further example, the mass storage device further comprises a disc drive and the manager 1080 references only the MSVBPI table 1070 to retrieve a number of sectors per track VBPI parameter.

It is to be understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

We claim:

1. A computerized method for configuring an electronic device, the method comprising steps of:
(a) compiling firmware code; and
(b) generating a representation of a minimized sector variable-bits-per-inch table from a first set of variable-bits-per-inch parameters.

2. The computerized method of claim 1, wherein the generating step (b) is performed after the compiling step (a).

3. The computerized method of claim 1, wherein the electronic device further comprises a mass storage device and the method further comprises:
(c) downloading the representation of a minimized sector variable-bits-per-inch table to a recording medium of the mass storage device; and
(d) downloading the firmware code to a read-only-memory of the mass storage device.

4. The computerized method of claim 3, wherein the mass storage device further comprises a disc drive and the downloading step (c) further comprises:
(c)(1) downloading the representation of a minimized sector variable-bits-per-inch table to a system sector of the recording medium of the disc drive.

5. The computerized method of claim 3, wherein the downloading step (d) is performed before the downloading step (c).

6. The computerized method of claim 1, the method further comprising:
(c) receiving a second set of variable-bits-per-inch parameters; and
(d) generating the representation of a minimized sector variable-bits-per-inch table from the second set of variable-bits-per-inch parameters.

7. The computerized method of claim 1, the method further comprising:
(c) generating the representation of a minimized sector variable-bits-per-inch table from the set of variable-bits-per-inch parameters that was most recently received.

8. A computerized method for obtaining at least one variable-bits-per-inch parameter of an electronic device, the method comprising steps of:
(a) receiving a request for the at least one variable-bits-per-inch parameter of the electronic device, the request including an indication of a head and an indication of a zone; and
(b) obtaining the at least one variable-bits-per-inch parameter of the electronic device from a minimized sector variable-bits-per-inch table, from the indication of the head and an indication of the zone.

9. The computerized method of claim 8, wherein the obtaining step (b) further comprises:
(b)(1) generating a query for the at least one variable-bits-per-inch parameter of the electronic device, from the indication of a head and an indication of a zone;
(b)(2) transmitting the query to a manager of the minimized sector variable-bits-per-inch table; and
(b)(3) receiving the at least one variable-bits-per-inch parameter.

10. The computerized method of claim 8, wherein the electronic device further comprises a mass storage device and the minimized sector variable-bits-per-inch table is stored on a system sector of the recording medium of the mass storage device.

11. The computerized method of claim 10, wherein the mass storage device further comprises a disc drive.

12. A computerized apparatus for configuring an electronic device, the apparatus comprising:
a compiler of firmware code; and
a generator of a representation of a minimized sector variable-bits-per-inch table from a first set of variable-bits-per-inch parameters, the generator operably coupled to the compiler.

13. The computerized apparatus of claim 12, wherein the electronic device further comprises a mass storage device and the apparatus further comprises:
a downloader of the representation of a minimized sector variable-bits-per-inch table to a recording medium of the mass storage device, operably coupled to the generator; and
a downloader of the firmware code to a read-only-memory of the mass storage device, operably coupled to the compiler.

14. The computerized apparatus of claim 13, wherein the mass storage device further comprises a disc drive and the downloader of the representation further comprises:
a downloader of the representation of a minimized sector variable-bits-per-inch table to a system sector of the recording medium of the disc drive.

15. A computerized apparatus for obtaining at least one variable-bits-per-inch parameter of an electronic device, the apparatus comprising:
a receiver of a request for the at least one variable-bits-per-inch parameter of the electronic device, the request including an indication of a head and an indication of a zone; and
an obtainer of the at least one variable-bits-per-inch parameter of the electronic device from the minimized sector variable-bits-per-inch table, from the indication of the head and an indication of the zone.

16. The computerized apparatus of claim 15, wherein the obtainer further comprises:
a generator of a query for the at least one variable-bits-per-inch parameter of the electronic device, from the indication of a head and an indication of a zone;
a transmitter of the query to a manager of the minimized sector variable-bits-per-inch table; and
a receiver of the at least one variable-bits-per-inch parameter from the manager.

17. The computerized apparatus of claim 15, wherein the electronic device further comprises a mass storage device and the minimized sector variable-bits-per-inch table is stored on a system sector of the recording medium of the mass storage device.

18. The computerized apparatus of claim 17, wherein the mass storage device further comprises a disc drive.

19. The computerized apparatus of claim 18, wherein the manager references only the minimized sector variable-bits-per-inch table to retrieve a number of sectors per track variable-bits-per-inch parameter.

20. A system for configuring an electronic device comprising:
a processor; and
means operative on the processor for managing a minimized representation of a sector variable-bits-per-inch table of a disc drive, the representation including an index to a disc drive head, an index to a disc drive zone, and an associated sector-per-track data.
